(19) United States
(12) Patent Application Publication
(10) Pub. No.: US 2025/0065826 A1
(43) Pub. Date: Feb. 27, 2025

(54) WIRE HARNESS DESIGNING METHOD, WIRE HARNESS MANUFACTURING METHOD, AND VEHICLE WIRE HARNESS

(71) Applicant: Yazaki Corporation, Tokyo (JP)

(72) Inventors: Katsumi Sato, Shizuoka (JP); Nobuhiro Sugiyama, Shizuoka (JP); You Yanagida, Shizuoka (JP); Naomi Kisu, Shizuoka (JP); Hiromu Tashiro, Shizuoka (JP)

(21) Appl. No.: 18/948,011

(22) Filed: Nov. 14, 2024

Related U.S. Application Data
(63) Continuation of application No. PCT/JP2023/040658, filed on Nov. 10, 2023.

(30) Foreign Application Priority Data
Nov. 16, 2022 (JP) 2022-183630

(51) Int. Cl. B60R 16/02; G06F 30/18; G06F 113/16; H01B 7/00

(52) U.S. Cl. CPC B60R 16/0207; G06F 30/18; H01B 7/0045; G06F 2113/16

(57) ABSTRACT

A wire harness designing method includes, while classifying components provided in an entire circuit of a vehicle wire harness into three layers, that is, an upstream circuit, an independent domain circuit, and a zone circuit, according to differences in category, determining a configuration of a first sub-harness belonging to the upstream circuit; determining a configuration of a second sub-harness belonging to the independent domain circuit; determining a configuration of a third sub-harness belonging to the zone circuit; and integrating the first sub-harness, the second sub-harness, and the third sub-harness.

### CROSS-REFERENCE TO RELATED APPLICATIONS

This is a continuation of International Application No. PCT/JP2023/040658 filed on Nov. 10, 2023, and claims priority from Japanese Patent Application No. 2022-183630 filed on Nov. 16, 2022, the entire content of which is incorporated herein by reference.

### TECHNICAL FIELD

The present disclosure relates to a wire harness designing method, a wire harness manufacturing method, and a vehicle wire harness.

### BACKGROUND ART

In a vehicle, it is necessary to supply source power from an in-vehicle power source device to various types of electrical components (auxiliary devices) disposed in various portions in a distributed manner. In addition, it is necessary to transmit signals or perform data communication between the plurality of electrical components. Such power supply, signal transmission, data communication, and the like are generally performed via electric wires provided in a wire harness. Therefore, the wire harness includes a large number of electric wires and has a complicated shape.

For example, a communication system having a configuration illustrated in FIG. 1 of JP2021-129278A includes a central gateway 11 and a plurality of zone ECUs (electronic control units) 41 and 42. In addition, the central gateway and each of the zone ECUs are connected to each other, and various electrical components 18 are connected downstream of each zone ECU via joint connectors (J/C).

In the case of implementing the communication system as illustrated in FIG. 1 of JP2021-129278A, a large number of electrical components can be managed intensively by the central gateway. However, it is necessary to connect all the electrical components to the central gateway, and thus the number of electric wires in the wire harness for connecting these electrical components and the central gateway increases, making an outer diameter thereof larger. Therefore, it is difficult to perform a routing work when the wire harness is assembled on the vehicle body.

In a case in which a plurality of independent zone ECUs are disposed for each region of the vehicle body, it is possible to shorten a length of the electric wires in the wire harness for connecting the electrical components of each portion and the zone ECUs. However, in a case in which a large number of electrical components are intensively arranged in the same region, the number of electrical components connected downstream of each zone ECU increases, and thus a processing load on the zone ECU may become very large.

On the other hand, among the electrical components mounted on the vehicle, for example, ECUs for advanced driver-assistance systems (ADAS) or human machine interface (HMI) systems have a fast evolution speed, and thus need to be frequently replaced according to connection specifications or control specifications. Furthermore, for example, there are many types of variations in an ECU for a powertrain system, and each type has a different control method, and thus each type requires a wire harness having a significantly different configuration.

Therefore, in a case in which the ECUs of auxiliary devices such as the ADAS system, the HMI system, and the powertrain system are connected downstream of the zone ECUs close to respective arrangement positions, it is necessary to frequently redesign the entire wire harness every time specifications or types of the auxiliary devices change, and an increase in a burden of a design work is unavoidable. Further, when the design of the wire harness is changed, it is necessary to remake a wire harness corresponding to new specifications, and it is difficult to reuse a wire harness having existing specifications.

The present disclosure has been made in view of the above circumstances, and an object of the present disclosure is to provide a wire harness designing method, a wire harness manufacturing method, and a vehicle wire harness capable of reducing a burden of a design work or a manufacturing work of a wire harness in response to a specification change or a type change of various auxiliary devices mounted on a vehicle.

### SUMMARY

The object of the present disclosure is implemented by the following configuration.

A wire harness designing method including:
while classifying components provided in an entire circuit of a vehicle wire harness into three layers, that is, an upstream circuit, an independent domain circuit, and a zone circuit, according to differences in category,
determining a configuration of a first sub-harness belonging to the upstream circuit;
determining a configuration of a second sub-harness belonging to the independent domain circuit;
determining a configuration of a third sub-harness belonging to the zone circuit; and
integrating the first sub-harness, the second sub-harness, and the third sub-harness.

A wire harness manufacturing method including:
classifying components provided in an entire circuit of a vehicle wire harness into three layers, that is, an upstream circuit, an independent domain circuit, and a zone circuit, according to differences in category;
manufacturing the component belonging to the upstream circuit as a first sub-harness;
manufacturing the component belonging to the independent domain circuit as a second sub-harness;
manufacturing the component belonging to the zone circuit as a third sub-harness; and
combining and integrating the manufactured first sub-harness, second sub-harness, and third sub-harness.

A vehicle wire harness including:
a first sub-harness that constitutes an upstream circuit common to a plurality of vehicle types among components provided in an entire circuit of the vehicle wire harness;
a second sub-harness that constitutes an independent domain circuit belonging to a specific function on a vehicle among the components provided in the entire circuit of the vehicle wire harness;
a third sub-harness that constitutes a zone circuit belonging to a specific region on a vehicle body other than the specific function among the components provided in the entire circuit of the vehicle wire harness; and
a common circuit connection unit that electrically connects common portions of the circuits of the first sub-harness, the second sub-harness, and the third sub-harness.

According to the wire harness designing method, the wire harness manufacturing method, and the vehicle wire harness of the present disclosure, it is possible to reduce a burden of a design work or a manufacturing work of the wire harness in response to a specification change or a type change of various auxiliary devices mounted on the vehicle.

The present disclosure has been briefly described above. Further, the details of the present disclosure can be clarified by reading modes (hereinafter, referred to as “embodiments”) for carrying out the disclosure to be described below with reference to the accompanying drawings.

### BRIEF DESCRIPTION OF DRAWINGS

FIG. 1 is a perspective view illustrating an example of external appearances of sub-harnesses classified into three layers;

FIG. 2 is a block diagram illustrating a connection state of a circuit provided in each sub-harness;

FIG. 3 is a perspective view illustrating an example of external appearances of circuit integration units that integrate circuits of a plurality of sub-harnesses;

FIG. 4 is a plan view illustrating a representative example of an arrangement state of circuits on a vehicle body;

FIG. 5 is a flowchart illustrating an example of a processing procedure of a wire harness designing method according to an embodiment of the present disclosure; and

FIG. 6 is a flowchart illustrating an example of a processing procedure of a wire harness manufacturing method according to an embodiment of the present disclosure.

### DESCRIPTION OF EMBODIMENTS

A specific embodiment of the present disclosure will be described below with reference to the drawings.

### <Basic Design Concept>

In the embodiment of the present disclosure, the entire components constituting a wire harness are classified into three layers, and an independent sub-harness is constituted for each of the three layers. Then, the three layers of sub-harnesses are integrated to finally form one set of wire harness. A wire harness obtained by integrating a plurality of layers of sub-harnesses into one body may be manufactured, or a plurality of layers of independent sub-harnesses may be integrated when the plurality of layers of sub-harnesses that can be integrated are individually manufactured and then assembled on a vehicle body.

A first sub-harness WH1 constituting a first layer is a component necessary for connecting upstream circuits serving as trunk lines in a wire harness mounted on a vehicle. The upstream circuit is a portion of the vehicle in which common hardware can be used in a standard and universal manner over a long period of time, and specifically, is a circuit that integrates a body system ECU and a chassis system ECU of the vehicle.

A second sub-harness WH2 constituting a second layer is a component necessary for connecting independent domain circuits that are desirably managed independently for each system. Specifically, circuits that have a fast evolution speed and need to be frequently replaced, such as an ADAS system ECU or an HMI system ECU, or circuits necessary for connecting systems having many types of variations and significantly different control methods for each type, such as a powertrain system ECU, correspond to the independent domain circuits.

A third sub-harness WH3 constituting a third layer is a component necessary for connecting zone circuits that are desirably managed separately for each region (zone) on the vehicle body, other than the above upstream circuits and the above independent domain circuits.

### <Specific Example of External Appearance>

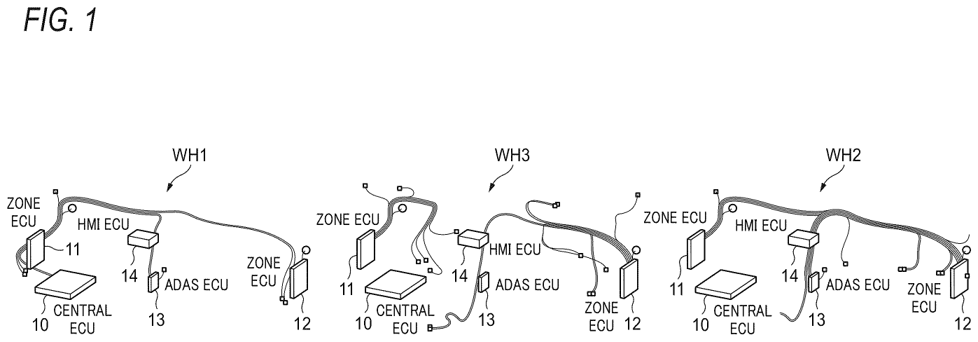

FIG. 1 illustrates an example of external appearances of the sub-harnesses classified into three layers. The first sub-harness WH1, the second sub-harness WH2, and the third sub-harness WH3 illustrated in FIG. 1 represent an example of external appearances of the components of portions, among the wire harness and other equipment such as various ECUs mounted on the vehicle, which are routed in the vicinity of an instrument panel.

The wire harness of the present embodiment is implemented by combining and integrating the first sub-harness WH1, the second sub-harness WH2, and the third sub-harness WH3 illustrated in FIG. 1, for example.

In the example illustrated in FIG. 1, a central ECU 10, zone ECUs 11 and 12, an ADAS ECU 13, an HMI ECU 14, and the like are arranged in the vicinity of the instrument panel. The zone ECU 11 is arranged on a left side of the instrument panel, and the zone ECU 12 is arranged on a right side of the instrument panel.

As illustrated in FIG. 1, the first sub-harness WH1 can connect the upstream circuits. That is, the first sub-harness WH1 includes an upstream circuit that connects the central ECU 10 and the zone ECUs 11 and 12, an upstream circuit that connects the central ECU 10 and the ADAS ECU 13 and the HMI ECU 14, and an upstream circuit that connects the zone ECUs 11 and 12 and the ADAS ECU 13 and the HMI ECU 14.

As illustrated in FIG. 1, the second sub-harness WH2 includes an independent domain circuit that connects the central ECU 10 and the ADAS ECU 13, and an independent domain circuit that connects the central ECU 10 and the HMI ECU 14.

In addition, as illustrated in FIG. 1, the third sub-harness WH3 includes a zone circuit that connects the zone ECU 11 or 12 of each zone and terminal devices in the same zone.

### <Connection State of Each Circuit>

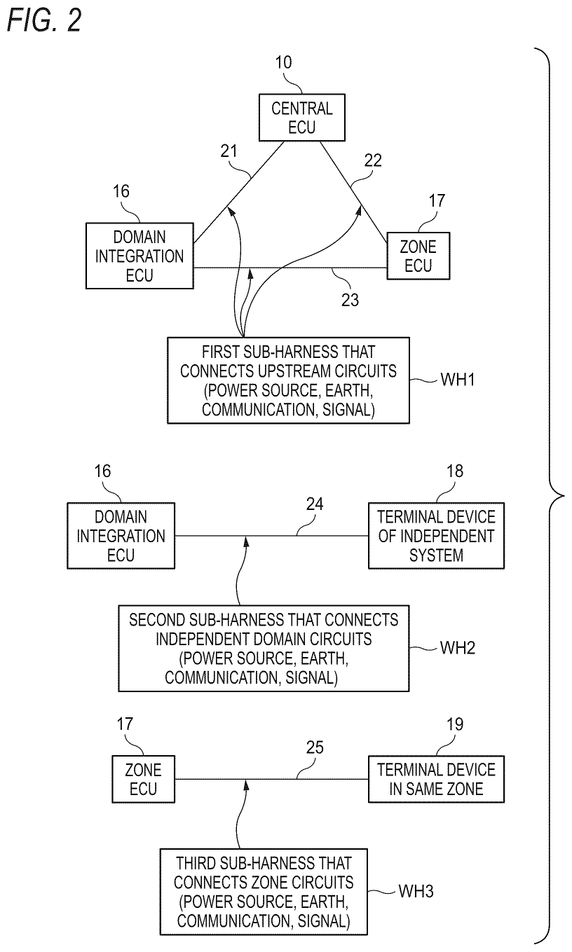

FIG. 2 illustrates a connection state of a circuit provided in each sub-harness. A domain integration ECU 16 illustrated in FIG. 2 corresponds to, for example, the ADAS ECU 13 or the HMI ECU 14 illustrated in FIG. 1. In addition, a zone ECU 17 illustrated in FIG. 2 corresponds to, for example, the zone ECUs 11 and 12 illustrated in FIG. 1.

The first sub-harness WH1 includes upstream circuits 21, 22, and 23. The upstream circuit 21 connects the central ECU 10 and the domain integration ECU 16. The upstream circuit 22 connects the central ECU 10 and the zone ECU 17. The upstream circuit 23 connects the domain integration ECU 16 and the zone ECU 17.

Each of the upstream circuits 21, 22, and 23 provided in the first sub-harness WH1 includes electric wires for connecting a power source, an earth (ground), communication, and a signal.

The second sub-harness WH2 includes an independent domain circuit 24 that connects the domain integration ECU 16 and a terminal device 18 of an independent system. The independent domain circuit 24 includes electric wires for connecting a power source, an earth, communication, and a signal.

The third sub-harness WH3 includes a zone circuit 25 that connects the zone ECU 17 and a terminal device 19 in the same zone. The zone circuit 25 includes electric wires for connecting a power source, an earth, communication, and a signal.

### <Example of Circuit Integration Unit>

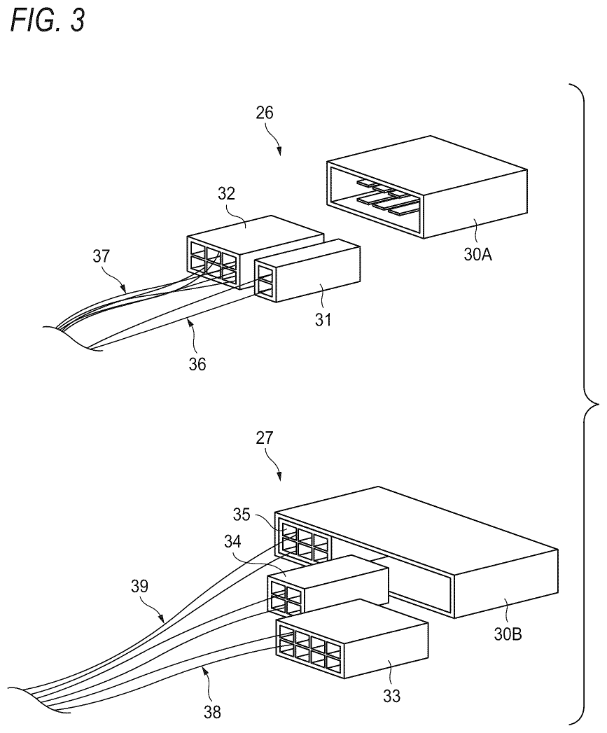

FIG. 3 illustrates an example of external appearances of circuit integration units 26 and 27 that integrate the circuits of the plurality of sub-harnesses.

When the first sub-harness WH1, the second sub-harness WH2, and the third sub-harness WH3 classified into three layers as described above are integrated and assembled on the vehicle body, it is necessary to connect common circuits between the plurality of sub-harnesses.

For example, a circuit that supplies source power from upstream to downstream or a circuit that handles a common signal is required to be commonly connected to the circuits of the plurality of layers of sub-harnesses. However, when the common circuits are connected to each other by using joint connectors or the like, a work process may be necessary for integrating the plurality of sub-harnesses, or the number of components may be increased.

The circuit integration unit 26 illustrated in FIG. 3 includes a common connector 30A and a plurality of sub-harness side connectors 31 and 32. An opening portion of the common connector 30A is formed into a shape and a size that coincide with an entire outer shape of the two sub-harness side connectors 31 and 32 in a state in which the two sub-harness side connectors 31 and 32 are arranged at positions adjacent to each other.

Therefore, the common connector 30A and the two sub-harness side connectors 31 and 32 can be assembled to be integrated into one body. A circuit on a sub-harness 36 side and a circuit on a sub-harness 37 side can be commonly connected to each other via a circuit on a common connector 30A side.

The common connector 30A can be mounted on a housing of an ECU of an auxiliary device or the like. Therefore, the common circuits of the plurality of layers of sub-harnesses can be connected to each other using an internal circuit on an ECU side. Therefore, the first sub-harness WH1, the second sub-harness WH2, and the third sub-harness WH3 can be individually manufactured in independent processes.

The circuit integration unit 27 illustrated in FIG. 3 includes a common connector 30B and three sub-harness side connectors 33, 34, and 35. An opening portion of the common connector 30B is formed into a shape and a size that coincide with an entire outer shape of the three sub-harness side connectors 33 to 35 in a state in which the three sub-harness side connectors 33 to 35 are arranged at positions adjacent to one another.

Therefore, the common connector 30B and the three sub-harness side connectors 33 to 35 can be assembled to be integrated into one body. The circuits of the plurality of sub-harnesses can be commonly connected to each other via a circuit on a common connector 30B side.

In the above description, the example of the circuit integration using the common connectors 30A and 30B has been described, and as another general example, the circuit integration may be performed by directly inserting empty cavities of the connector provided in at least one of sub-harnesses with terminals provided in the other sub-harness without using the common connectors although the workability is poor, and integrating the terminals into one connector.

### <Arrangement Example of Components on Vehicle Body>

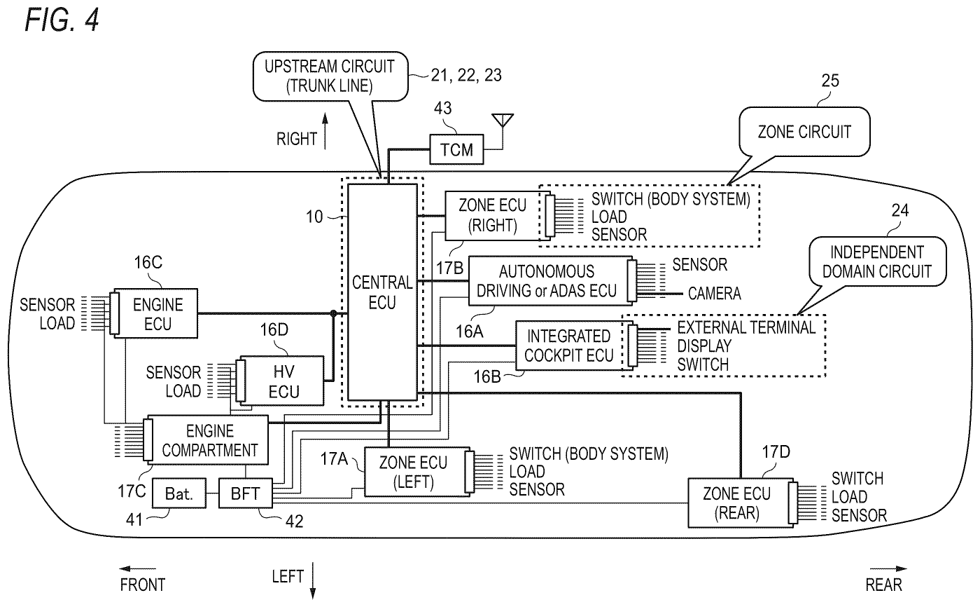

FIG. 4 illustrates a representative example of an arrangement state of the circuits on the vehicle body.

In the example illustrated in FIG. 4, the central ECU 10 is arranged in the vicinity of an instrument panel of a vehicle body 40, and zone ECUs 17A and 17B are arranged on left and right sides of the central ECU 10, respectively.

Domain integration ECUs 16A and 16B are arranged in the vicinity of the instrument panel. One domain integration ECU 16A is an ECU having an automatic driving function or an ADAS function. The other domain integration ECU 16B is an ECU having an integrated cockpit function.

On the other hand, a zone ECU 17C, domain integration ECUs 16C and 16D, an in-vehicle battery (BAT) 41, a BFT 42, and various terminal devices (sensors, loads, and the like) are disposed in a region of an engine compartment of the vehicle body 40. The domain integration ECU 16C is an ECU having an engine control function, and the domain integration ECU 16D is an ECU having a hybrid control function.

In addition, a zone ECU 17D and various terminal devices (switch, sensor, load, and the like) are disposed in a region on a rear side of the vehicle body 40.

As illustrated in FIG. 4, the sub-harness constituting the upstream circuits 21 to 23 connects the central ECU 10, the zone ECUs 17A, 17B, 17C, and 17D, and the domain integration ECUs 16A, 16B, 16C, and 16D. The sub-harness includes a power source line, a signal line, a communication line, and the like.

The sub-harness constituting the zone circuit 25 connects the zone ECU 17B and terminal devices (body system switch, load, sensor, and the like) arranged in the same region (or at positions close to the zone ECU 17B). Similarly, the zone ECU 17A and terminal devices (body system switch, load, sensor, and the like) arranged in the same region are connected to each other by the sub-harness constituting the zone circuit.

Further, terminal devices (load, sensor, and the like) arranged in the region of the engine compartment of the vehicle body 40 other than an independent domain system are connected to the zone ECU 17C via the sub-harness constituting the zone circuit in the same region. Further, the terminal devices (switch, load, sensor, and the like) arranged in the region on the rear side of the vehicle body 40 other than an independent domain system are connected to the zone ECU 17D via the sub-harness constituting the zone circuit in the same region.

On the other hand, the sub-harness constituting the independent domain circuit 24 connects the domain integration ECU 16B and terminal devices (external terminal, display, switch, and the like) provided in the system thereof. Similarly, the domain integration ECU 16A and terminal devices (sensor, camera, and the like) provided in the same system are connected to each other by the sub-harness constituting the independent domain circuit.

### <Wire Harness Designing Procedure>

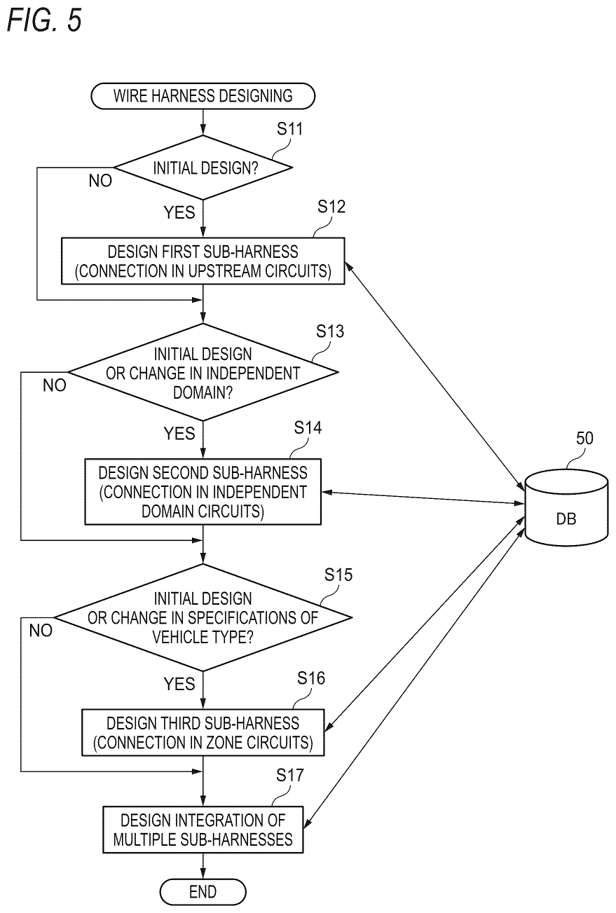

FIG. 5 illustrates an example of a processing procedure of a wire harness designing method according to an embodiment of the present disclosure.

When a designer actually designs a wire harness, a design-assistance system including a computer is used to design the wire harness according to a procedure as illustrated in FIG. 5 in accordance with a predetermined rule based on the contents of a database (DB) 50 that stores information on the vehicle on which a wire harness to be designed is mounted.

The database 50 holds data determined in advance such as a shape and dimensions for each vehicle type of the vehicle, a type and specifications of each device mounted on the vehicle, and an installation position of each device. The processing procedure in FIG. 5 will be described below.

When a wire harness of the vehicle to be newly produced is initially designed, the process proceeds from steps S11 and S12. Then, the design-assistance system designs the first sub-harness WH1 in accordance with an input operation of the designer.

For example, as illustrated in FIG. 4, arrangement positions or basic specifications of main devices such as the central ECU 10, the domain integration ECUs 16A, 16B, 16C, 16D, the zone ECUs 17A, 17B, 17C, 17D, the in-vehicle battery 41, and the BFT 42 are determined in advance and registered in the database 50. Therefore, as in the first sub-harness WH1 illustrated in FIG. 2, the designer designs, in step S12, the first sub-harness WH1 including the upstream circuit 21 that connects the central ECU 10 and the domain integration ECU 16, the upstream circuit 22 that connects the central ECU 10 and the zone ECU 17, and the upstream circuit 23 that connects the domain integration ECU 16 and the zone ECU 17. Each of the upstream circuits 21, 22, and 23 includes a power source line, an earth line, a communication line, and a signal line. For example, a thickness of the power source line to be used is determined according to the basic specifications of the vehicle.

Hardware at a portion to which each of the upstream circuits 21, 22, and 23 is connected is not changed for a long period of time, and thus can be used in a standard and universal manner. Therefore, a design work of the first sub-harness WH1 is required only once for a first time.

When the wire harness of the vehicle to be newly produced is initially designed, or when a change in specifications of the independent domain is made, the process proceeds from steps S13 and S14. Then, the design-assistance system designs the second sub-harness WH2 in accordance with an input operation of the designer.

That is, as in the second sub-harness WH2 illustrated in FIG. 2, the independent domain circuit 24 that connects the domain integration ECU 16 and the terminal device 18 of the independent system is implemented by the second sub-harness WH2. The independent domain circuit 24 includes a power source line, an earth line, a communication line, and a signal line.

For example, in the case of the vehicle illustrated in FIG. 4, four second sub-harnesses WH2, that is, the second sub-harness WH2 that connects the domain integration ECU 16A and the downstream terminal devices thereof, the second sub-harness WH2 that connects the domain integration ECU 16B and the downstream terminal devices thereof, the second sub-harness WH2 that connects the domain integration ECU 16C and the downstream terminal devices thereof, and the second sub-harness WH2 that connects the domain integration ECU 16D and the downstream terminal devices thereof, are designed for each independent domain.

When the wire harness of the vehicle to be newly produced is initially designed, or when a change in specifications of a vehicle type is made, the process proceeds from steps S15 and S16. Then, the design-assistance system designs the third sub-harness WH3 in accordance with an input operation of the designer.

That is, as in the third sub-harness WH3 illustrated in FIG. 2, the zone circuit 25 that connects the zone ECU 17 and the terminal device 19 in the same zone is implemented by the third sub-harness WH3. The zone circuit 25 includes a power source line, an earth line, a communication line, and a signal line.

For example, in the case of the vehicle illustrated in FIG. 4, a plurality of third sub-harnesses WH3 to be described below are individually designed for each region.
a third sub-harness WH3 that connects the zone ECU 17A in a left region of the instrument panel and various terminal devices (body system switch, load, sensor, and the like) in a left region of a vehicle interior
a third sub-harness WH3 that connects the zone ECU 17B in a right region of the instrument panel and various terminal devices (body system switch, load, sensor, and the like) in a right region of the vehicle interior
a third sub-harness WH3 that connects the zone ECU 17C in the region of the engine compartment and various terminal devices (body system load, sensor, and the like, excluding a powertrain system) in the same engine compartment-a third sub-harness WH3 that connects the zone ECU 17D in a rear region of the vehicle interior and various terminal devices (body system switch, load, sensor, and the like) in the same rear region

After the design of the first sub-harness WH1, the second sub-harness WH2, and the third sub-harness WH3 is completed, those sub-harnesses are integrated in step S17 to design a completed wire harness. For example, when the first sub-harness WH1 and the second sub-harness WH2 are combined and integrated, the integrated sub-harness (WH1+WH2) and the third sub-harness WH3 are designed as separate bodies and are assembled simultaneously on the same vehicle body.

In addition, a design is made in which the common circuits among the circuits provided in the first sub-harness WH1, the second sub-harness WH2, and the third sub-harness WH3 are connected to each other so as to straddle the plurality of sub-harnesses. In a specific example, as in the circuit integration units 26 and 27 illustrated in FIG. 3, device specifications in which the plurality of sub-harness side connectors 31 and 32 (or 33 to 35) are arranged side by side to be connected to the common connectors 30A and 30B, or common circuits are electrically connected inside the ECU on the common connector 30A side are designed.

Accordingly, it is possible to form a path for supplying source power from upstream to a downstream load among the plurality of sub-harnesses, connect common communication paths to each other between the plurality of sub-harnesses, or connect common signal paths to each other between the plurality of sub-harnesses.

Design data of the wire harness generated by the above design is registered in, for example, the database 50, and is used when a wire harness is manufactured or when a design change is made to a designed wire harness.

When a change in specifications of the previously designed vehicle is made, an optional device may be added, or a change in specifications of the existing device may be made. However, such a change does not affect the configuration of the first sub-harness WH1, and thus a design change of the first sub-harness WH1 is unnecessary.

On the other hand, in a case in which a change in vehicle specifications is made such that a change is made to a system of the independent domain system, it is necessary to change the configuration of the second sub-harness WH2 for each system of an independent system, and thus step S14 in FIG. 5 is executed to change the design of the second sub-harness WH2.

On the other hand, when a change is made to the body system and the chassis system other than the independent domain system in accordance with the addition of a new vehicle type or the change in specifications for each vehicle type, a connection state of each zone circuit 25 of the corresponding system is affected, and thus step S16 in FIG. 5 is executed to change the design of the third sub-harness WH3.

### <Wire Harness Manufacturing Procedure>

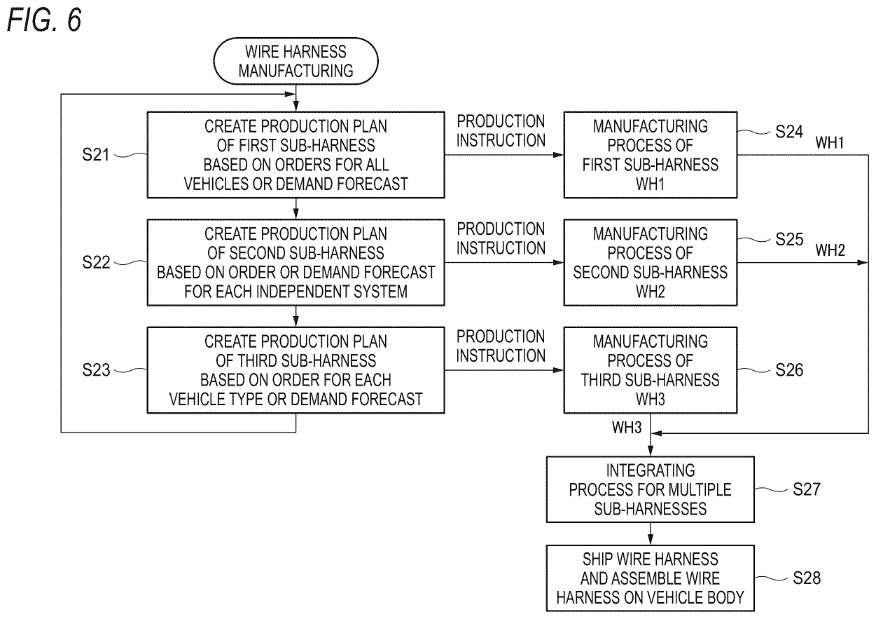

FIG. 6 illustrates an example of a processing procedure of a wire harness manufacturing method according to an embodiment of the present disclosure. When the wire harness designed by using the method illustrated in FIG. 5 is actually manufactured by a component manufacturer, it is assumed that the wire harness is manufactured in a processing procedure as illustrated in FIG. 6. The processing procedure in FIG. 6 will be described below.

The component manufacturer that manufactures a wire harness creates a production plan (quantity, production schedule, and the like) of the first sub-harness WH1, which is a component common to all vehicle types, based on an actual order situation from a vehicle manufacturer or a future demand forecast (step S21).

In addition, in accordance with the production plan determined in step S21, the component manufacturer instructs a manufacturing plant of the component manufacturer or a related company to produce the first sub-harness WH1 (step S24).

The component manufacturer that manufactures a wire harness creates a production plan (quantity, production schedule, and the like) of the second sub-harness WH2, which is a different component for each vehicle type, for each of the independent systems (ADAS system, HMI system, powertrain system, and the like) mounted on a vehicle to be produced by the vehicle manufacturer, based on the actual order situation for each vehicle type or the future demand forecast (step S22).

In addition, in accordance with the production plan determined in step S22, the component manufacturer instructs the manufacturing plant of the component manufacturer or the related company to produce the second sub-harness WH2 (step S25).

The component manufacturer that manufactures a wire harness creates a production plan (quantity, production schedule, and the like) of the third sub-harness WH3, which is a different component for each vehicle type, based on an actual order situation for each vehicle type from the vehicle manufacturer or the future demand forecast (step S23).

In addition, in accordance with the production plan determined in step S23, the component manufacturer instructs the manufacturing plant of the component manufacturer or the related company to produce the third sub-harness WH3 (step S26).

The component manufacturer that manufactures a wire harness collects the first sub-harness WH1, the second sub-harness WH2, and the third sub-harness WH3 manufactured in the manufacturing plant of the component manufacturer or the related company in the same plant, integrates the first sub-harness WH1, the second sub-harness WH2, and the third sub-harness WH3 for each vehicle type (step S27), and ships the wire harness as a finished wire harness for each vehicle type to be delivered to the vehicle manufacturer (step S28). The vehicle manufacturer assembles the delivered wire harness on the vehicle body to produce the vehicle.

When the wire harness manufacturing method illustrated in FIG. 6 is executed, the first sub-harness WH1, the second sub-harness WH2, and the third sub-harness WH3 can be manufactured in an independent state. That is, the first sub-harness WH1, the second sub-harness WH2, and the third sub-harness WH3 can be manufactured in respective plants at different places, and different numbers of the first sub-harness WH1, the second sub-harness WH2, and the third sub-harness WH3 can be manufactured at different times. Accordingly, it is possible to optimize a manufacturing situation of the wire harness in accordance with a variation in the actual order situation or the demand forecast.

As described above, in the wire harness designing method and the wire harness manufacturing method according to the present embodiment, the components of the wire harness are classified into three layers, and the first sub-harness WH1, the second sub-harness WH2, and the third sub-harness WH3 as illustrated in FIGS. 1 and 2 are manufactured respectively and integrated into one body. Therefore, efficient production of the wire harness becomes possible. In addition, the first sub-harness WH1 is less likely to be affected by differences in the vehicle types, and thus can be mass-produced, which is expected to lead to cost reduction through economies of scale.

The second sub-harness WH2 that connects the independent domain circuits and the third sub-harness WH3 that connects the zone circuits are layered, and thus it is possible to prevent a large number of circuits connected downstream of the zone ECU 17 in each zone from concentrating and prevent the outer diameter of the sub-harness from increasing. Accordingly, it is possible to avoid difficulty in a work of routing the wire harness onto the vehicle body. In addition, by assigning circuits of a system whose specifications are changed frequently or a system with many types of variations to the second sub-harness WH2 as the independent domain system, frequent changes in the vehicle specifications can be accommodated by simply changing specifications of the second sub-harness WH2. Therefore, it is easy to change the design work or the manufacturing process of the wire harness corresponding to the change in the vehicle specifications. Further, a connection path of the circuits of each independent domain system becomes clear, and thus an examination work for optimizing the production method of the wire harness becomes easy.

The present disclosure is not limited to the above embodiments, and modifications, improvements, or the like can be made as appropriate. In addition, materials, shapes, dimensions, numbers, arrangement positions, and the like of components in the above embodiments are freely selected and are not limited as long as the present disclosure can be implemented.

Here, the features of the wire harness designing method, the wire harness manufacturing method, and the vehicle wire harness according to the embodiments of the present disclosure will be briefly summarized and listed in the following (i) to (v).

(i) A wire harness designing method including:
while classifying components provided in an entire circuit of a vehicle wire harness into three layers, that is, an upstream circuit (21 to 23), an independent domain circuit (24), and a zone circuit (25), according to differences in category (FIGS. 1 and 2),
a step (S12) of determining a configuration of a first sub-harness (WH1) belonging to the upstream circuit;
a step (S14) of determining a configuration of a second sub-harness (WH2) belonging to the independent domain circuit;
a step (S16) of determining a configuration of a third sub-harness (WH3) belonging to the zone circuit; and
a step (S17) of integrating the first sub-harness, the second sub-harness, and the third sub-harness.

According to the wire harness designing method including the steps in the above (i), for example, when the circuit configuration of the wire harness designed in the past is changed in accordance with a change in vehicle specifications or the like, a work of specifying a portion that is required to be changed in the design becomes easy, and the number of portions to be actually changed can also be reduced. That is, there is no need to change the design such as straddling the plurality of sub-harnesses, and thus the design change can be made on a sub-harness basis. Therefore, it is possible to reduce a burden of a work of a designer associated with the design change.

(ii) The wire harness designing method according to (i), in which
when the components of the vehicle wire harness are classified, a circuit element common to a plurality of vehicle types is allocated to the upstream circuit (21 to 23), a circuit element belonging to a specific function on a vehicle is allocated to the independent domain circuit (24), and a circuit element belonging to a specific region on a vehicle body other than the specific function is allocated to the zone circuit (25).

According to the wire harness designing method including the steps in the above (ii), there is almost no need to change the design of the first sub-harness. In addition, for example, when a new optional device is added or device specifications are changed in accordance with the change in the vehicle specifications for each vehicle type, there is a possibility that the design change can be completed by only changing the configuration of the third sub-harness WH3 that connects the zone circuits of the corresponding zone. Further, when system specifications of an independent domain system such as an ADAS system or an HMI system are changed, there is a possibility that the design change can be completed by only changing the configuration of the second sub-harness WH2 of the corresponding system.

(iii) A wire harness manufacturing method including:
a step of classifying components provided in an entire circuit of a vehicle wire harness into three layers, that is, an upstream circuit, an independent domain circuit, and a zone circuit, according to differences in category (see FIGS. 1 and 2);
a step (S24) of manufacturing the component belonging to the upstream circuit as a first sub-harness;
a step (S25) of manufacturing the component belonging to the independent domain circuit as a second sub-harness;
a step (S26) of manufacturing the component belonging to the zone circuit as a third sub-harness; and
a step (S27) of combining and integrating the manufactured first sub-harness, second sub-harness, and third sub-harness.

According to the wire harness manufacturing method including the steps in the above (iii), the first sub-harness, the second sub-harness, and the third sub-harness can be manufactured in an independent state. Therefore, it is also possible to manufacture the sub-harnesses in the respective plants at the different places for each type, and it is also possible to manufacture the sub-harnesses at different timings for each type. Therefore, it is easy to optimize a manufacturing process in accordance with a demand change for each type of the sub-harnesses or a delivery schedule.

(iv) A vehicle wire harness including:
a first sub-harness (WH1) that constitutes an upstream circuit common to a plurality of vehicle types among components provided in an entire circuit of the vehicle wire harness;
a second sub-harness (WH2) that constitutes an independent domain circuit belonging to a specific function on a vehicle among the components provided in the entire circuit of the vehicle wire harness;
a third sub-harness (WH3) that constitutes a zone circuit belonging to a specific region on a vehicle body other than the specific function among the components provided in the entire circuit of the vehicle wire harness; and
a common circuit connection unit (circuit integration unit 26, 27) that electrically connects common portions of the circuits of the first sub-harness, the second sub-harness, and the third sub-harness.

According to the vehicle wire harness having the configuration in the above (iv), the first sub-harness, the second sub-harness, and the third sub-harness are present as independent components, and thus it is easy to change the design of the entire wire harness when the change in the vehicle specifications or the like is made. In addition, the first sub-harness, the second sub-harness, and the third sub-harness can be manufactured in the respective independent plants, and thus the manufacturing process can be easily optimized. Furthermore, it is possible to prevent a large number of devices from concentrating downstream of the zone ECU (17) of each zone, and thus it is possible to prevent an outer shape of the third sub-harness from becoming thick, and a routing work when the third sub-harness is assembled on the vehicle body becomes easy.

(v) The vehicle wire harness according to (iv), in which
the first sub-harness has a first connector (sub-harness side connector 33), the second sub-harness has a second connector (sub-harness side connector 34), and the third sub-harness has a third connector (sub-harness side connector 35), and
at least two of the first connector, the second connector, or the third connector have a shape capable of being simultaneously fitted to a common connector (30A and 30B) of a counterpart device in a state of being disposed at positions adjacent to each other (see FIG. 3).

According to the vehicle wire harness having the configuration in the above (v), when the first sub-harness, the second sub-harness, and the third sub-harness are integrated, common circuits can be connected to each other between the sub-harnesses without any special connection work. Further, there is no need to attach a special component such as a joint connector for connecting the circuits between the sub-harnesses, and thus the configuration can be simplified.

What is claimed is:

1. A wire harness designing method comprising:
while classifying components provided in an entire circuit of a vehicle wire harness into three layers, that is, an upstream circuit, an independent domain circuit, and a zone circuit, according to differences in category,
determining a configuration of a first sub-harness belonging to the upstream circuit;
determining a configuration of a second sub-harness belonging to the independent domain circuit;
determining a configuration of a third sub-harness belonging to the zone circuit; and
integrating the first sub-harness, the second sub-harness, and the third sub-harness.

2. The wire harness designing method according to claim 1, wherein
when the components of the vehicle wire harness are classified, a circuit element common to a plurality of vehicle types is allocated to the upstream circuit, a circuit element belonging to a specific function on a vehicle is allocated to the independent domain circuit, and a circuit element belonging to a specific region on a vehicle body other than the specific function is allocated to the zone circuit.

3. A wire harness manufacturing method comprising:
classifying components provided in an entire circuit of a vehicle wire harness into three layers, that is, an upstream circuit, an independent domain circuit, and a zone circuit, according to differences in category;
manufacturing the component belonging to the upstream circuit as a first sub-harness;
manufacturing the component belonging to the independent domain circuit as a second sub-harness;
manufacturing the component belonging to the zone circuit as a third sub-harness; and
combining and integrating the manufactured first sub-harness, second sub-harness, and third sub-harness.

4. A vehicle wire harness comprising:
a first sub-harness that constitutes an upstream circuit common to a plurality of vehicle types among components provided in an entire circuit of the vehicle wire harness;
a second sub-harness that constitutes an independent domain circuit belonging to a specific function on a vehicle among the components provided in the entire circuit of the vehicle wire harness;
a third sub-harness that constitutes a zone circuit belonging to a specific region on a vehicle body other than the specific function among the components provided in the entire circuit of the vehicle wire harness; and
a common circuit connection unit that electrically connects common portions of the circuits of the first sub-harness, the second sub-harness, and the third sub-harness.

5. The vehicle wire harness according to claim 4, wherein
the first sub-harness has a first connector, the second sub-harness has a second connector, and the third sub-harness has a third connector, and
at least two of the first connector, the second connector, or the third connector have a shape capable of being simultaneously fitted to a common connector of a counterpart device in a state of being disposed at positions adjacent to each other.
